(19) United States
(12) Patent Application Publication
(10) Pub. No.: US 2026/0332987 A1
(43) Pub. Date: Oct. 22, 2026

(54) COMMUNICATING A LOCATION OF A VEHICLE

(71) Applicant: Toyota Connected North America, Inc., Plano, TX (US)

(72) Inventors: Dustin William Lewis, McKinney, TX (US); Keaton Scott Taylor, Plano, TX (US); Jami Dow Watson, Highland Village, TX (US); Trevor Alan Allman, Little Elm, TX (US); Sara Elizabeth Collins, Plano, TX (US); Gnana Sai Teja Vemulapalli, Aubrey, TX (US)

(73) Assignee: Toyota Connected North America, Inc., Plano, TX (US)

(21) Appl. No.: 19/185,680

(22) Filed: Apr. 22, 2025

(51) Int. Cl. H04W 4/029; G06F 21/62

(52) U.S. Cl. CPC H04W 4/029; G06F 21/6245

(57) ABSTRACT

A system for communicating a location of a vehicle can include a processor and a memory. The memory can store a request reception module, a location positioning module, a cell identification module, and a transmission module. The request reception module can receive a request for the location of the vehicle. The location positioning module can determine a precise location of the vehicle. The cell identification module can determine an identification of a cell that contains the precise location. The cell can be of a grid that divides a surface of the Earth into contiguous cells. The transmission module can cause, in response to the request, a transmission of the identification of the cell, rather than the precise location, in order to complicate an ability of an entity to obtain information capable of identifying an occupant of the vehicle.

### TECHNICAL FIELD

The disclosed technologies are directed to communicating a location of a vehicle.

### BACKGROUND

Private information can be information that can be used to identify a specific person. Private information can include, for example, one or more of a real name of the specific person, an alias name of the specific person, a postal address of the specific person, a telephone number of the specific person, an e-mail address of the specific person, a social media account identifier of the specific person, credit card information associated with the specific person, a username associated with the specific person, a driver’s license number of the specific person, a license plate number of a vehicle associated with the specific person, a vehicle identification number (VIN) of the vehicle associated with the specific person, or the like. Because entities often maintain databases that can cross-index one item of private information (e.g., the real name of the specific person) with another item of private information (e.g., the credit card information associated with the specific person), efforts to restrict access to private information can be important to prevent harm to the specific person. Such harm can include, for example, one or more of identity theft, financial loss, reputation damage, discrimination, or the like. Geolocation information associated with the specific person can also be considered private information, particularly when the geolocation information is used to track movements of the specific person. Such geolocation information can be considered private information because information about locations, for example, associated with one or more of the postal address of the specific person, a work location of the specific person, or locations of places frequented by the specific person can be used to identify the specific person.

### SUMMARY

In an embodiment, a system for communicating a location of a vehicle can include a processor and a memory. The memory can store a request reception module, a location positioning module, a cell identification module, and a transmission module. The request reception module can include instructions that, when executed by the processor, cause the processor to receive a request for the location of the vehicle. The location positioning module can include instructions that, when executed by the processor, cause the processor to determine a precise location of the vehicle. The cell identification module can include instructions that, when executed by the processor, cause the processor to determine an identification of a cell that contains the precise location. The cell can be of a grid that divides a surface of the Earth into contiguous cells. The transmission module can include instructions that, when executed by the processor, cause the processor to cause, in response to the request, a transmission of the identification of the cell, rather than the precise location, in order to complicate an ability of an entity to obtain information capable of identifying an occupant of the vehicle.

In another embodiment, a method for communicating a location of a vehicle can include receiving, by a processor, a request for the location of the vehicle. The method can include determining, by a processor, a precise location of the vehicle. The method can include determining, by the processor, an identification of a cell that contains the precise location. The cell can be of a grid that divides a surface of the Earth into contiguous cells. The method can include causing, by the processor and in response to the request, a transmission of the identification of the cell, rather than the precise location, in order to complicate an ability of an entity to obtain information capable of identifying an occupant of the vehicle.

In another embodiment, a non-transitory computer-readable medium for communicating a location of a vehicle can include instructions that, when executed by one or more processors, cause the one or more processors to receive a request for the location of the vehicle. The non-transitory computer-readable medium can include instructions that, when executed by one or more processors, cause the one or more processors to determine a precise location of the vehicle. The non-transitory computer-readable medium can include instructions that, when executed by one or more processors, cause the one or more processors to determine an identification of a cell that contains the precise location. The cell can be of a grid that divides a surface of the Earth into contiguous cells. The non-transitory computer-readable medium can include instructions that, when executed by one or more processors, cause the one or more processors to cause, in response to the request, a transmission of the identification of the cell, rather than the precise location, in order to complicate an ability of an entity to obtain information capable of identifying an occupant of the vehicle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 includes a diagram that illustrates an example of an environment for communicating a location of a vehicle, according to the disclosed technologies.

FIG. 2 includes a diagram that illustrates another example of a grid for communicating a location of a vehicle, according to the disclosed technologies.

FIG. 3 includes a block diagram that illustrates an example of a system for communicating a location of a vehicle, according to the disclosed technologies.

FIG. 4 includes a flow diagram that illustrates an example of a method that is associated with communicating a location of a vehicle, according to the disclosed technologies

FIG. 5 includes a block diagram that illustrates an example of elements disposed on a vehicle, according to the disclosed technologies.

### DETAILED DESCRIPTION

The disclosed technologies are directed to communicating a location of a vehicle. A request for the location of the vehicle can be received. A precise location of the vehicle can be determined. For example, the precise location of the vehicle can be determined using a technique. For example, the technique can include one or more of: (1) a Global Navigation Satellite System (GNSS) technique, (2) a cellular network triangulation technique, (3) a technique that determines a location of a hotspot at which Internet access is obtainable via a wireless local-area network, (4) a technique that uses one or more of a gyroscope, disposed on the vehicle, or an accelerometer disposed on the vehicle, (5) a technique that uses a radio-frequency identification tag, (6) a technique that uses radio beacons, (7) a technique that uses surveillance cameras, (8) a technique that uses automatic number-plate recognition technology, or (9) the like. An identification of a cell that contains the precise location can be determined. The cell can be of a grid that divides a surface of the Earth into contiguous cells. In response to the request, a transmission of the identification of the cell, rather than the precise location of the vehicle, can be caused to occur in order to complicate an ability of an entity to obtain information capable of identifying an occupant of the vehicle. For example, a size of the cell can be sufficiently large that one or more other vehicles are likely also to be contained in the cell at a time of the transmission. Additionally, for example, the identification of the cell can include a spatial index of a spatial database. For example, the spatial database can include supplemental information associated with a location of the cell.

For example, cells, of the contiguous cells, can have one or more shapes. For example, the one or more shapes can include one or more of a square, a rectangle, a diamond, a triangle, a pentagon, a hexagon, or the like. For example, a specific cell, of the contiguous cells, can have a specific size. For example, the specific size can be a size deemed large enough to complicate the ability of the entity to obtain, using the identification of the cell, the information capable of identifying the occupant of the vehicle. For example, the specific size can be defined by a shortest distance from a center of the specific cell to an edge of the specific cell. For example, the specific size can be defined by one or more of a law, a statute, a regulation, a rule, or the like. Alternatively or additionally, for example, the specific size can be a function of a population density at the precise location of the vehicle. Alternatively or additionally, for example, the specific size can be a function of a vehicle density at the precise location of the vehicle.

For example: (1) the cell that contains the precise location can include a set of cells, (2) the identification of the cell that contains the precise location can include a set of identifications of the set of cells, (3) each cell, of the set of cells, can have a corresponding identification of the set of identifications, (4) each cell, of the set of cells, can have a corresponding size, and (4) a corresponding size of a first cell, of the set of cells, can be larger than a corresponding size of a second cell of the set of cells. For example, a specific cell that has a size deemed large enough to complicate the ability of the entity to obtain, using the identification of the specific cell, the information capable of identifying the occupant of the vehicle can be selected from the set of cells. For example, the transmission of the identification of the cell can include a transmission of an identification of the specific cell.

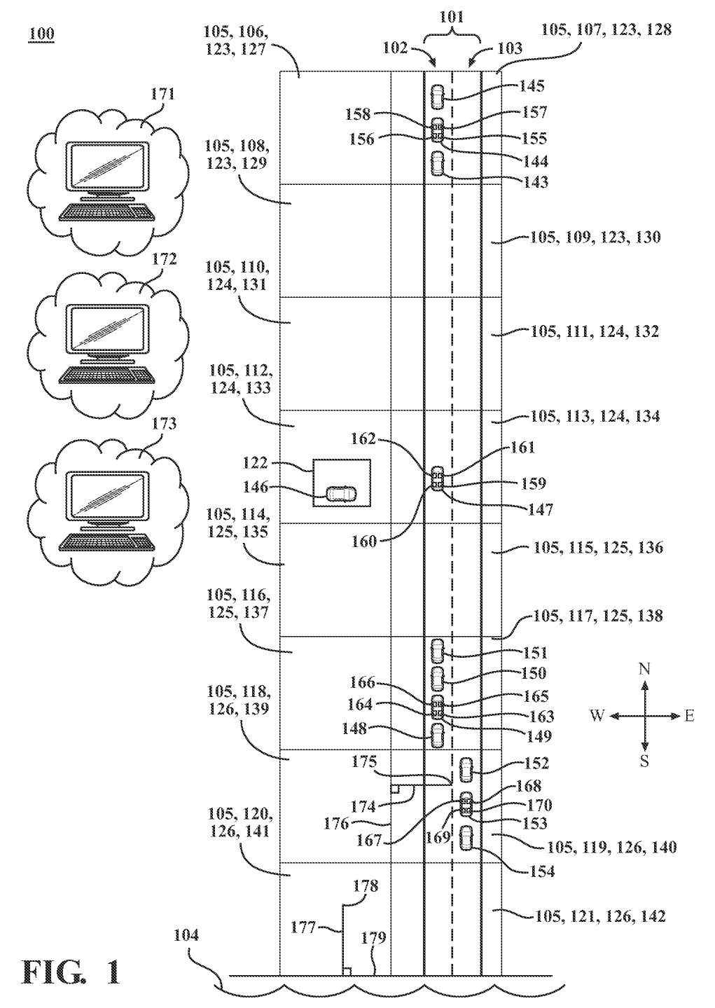

FIG. 1 includes a diagram that illustrates an example of an environment 100 for communicating a location of a vehicle, according to the disclosed technologies. The environment 100 can include a road 101 disposed along a line of longitude. The road 101 can include a southbound lane 102 and a northbound lane 103. A body of water 104 can be located south of a southern end of the road 101.

For example, the environment 100 can include a grid 105 that can divide a surface of the environment 100 into contiguous cells. For example, the grid 105 can include: (1) a cell 106 can be located at a northwest area of the environment 100, (2) a cell 107 can be located east of the cell 106, (3) a cell 108 can be located south of the cell 106, (4) a cell 109 can be located east of the cell 108, (5) a cell 110 can be located south of the cell 108, (6) a cell 111 can be located east of the cell 110, (7) a cell 112 can be located south of the cell 110, (8) a cell 113 can be located east of the cell 112, (9) a cell 114 can be located south of the cell 112, (10) a cell 115 can be located east of the cell 114, (11) a cell 116 can be located south of the cell 114, (12) a cell 117 can be located east of the cell 116, (13) a cell 118 can be located south of the cell 116, (14) a cell 119 can be located east of the cell 118, (15) a cell 120 can be located south of the cell 118, and (16) a cell 121 can be located east of the cell 120. Cells of the grid 105 can have one or more shapes. For example, each of the cell 106, the cell 107, the cell 108, the cell 109, the cell 110, the cell 111, the cell 112, the cell 113, the cell 114, the cell 115, the cell 116, the cell 117, the cell 118, and the cell 119 can be a square, and each of the cell 120 and the cell 121 can be a rectangle.

Additionally, for example, each of the cells of the grid 105 can be associated with a characterization of the location of the cell. For example, the characterization of the cell 106 can include that it is in an urban location, is on-road, and has a climate classification of “cold.” For example, the characterization of the cell 107 can include that it is in an urban location, is on-road, and has a climate classification of “cold.” For example, the characterization of the cell 108 can include that it is in an urban location, is on-road, and has a climate classification of “cold.” For example, the characterization of the cell 109 can include that it is in an urban location, is on-road, and has a climate classification of “cold.” For example, the characterization of the cell 110 can include that it is in a rural location, is off-road, and has a climate classification of “cool.” For example, the characterization of the cell 111 can include that it is in a rural location, is on-road, and has a climate classification of “cool.” For example, the characterization of the cell 112 can include that it is in a rural location, is off-road, has a climate classification of “cool,” and includes a national park 122. For example, the characterization of the cell 113 can include that it is in a rural location, is on-road, and has a climate classification of “cool.” For example, the characterization of the cell 114 can include that it is in a rural location, is off-road, and has a climate classification of “warm.” For example, the characterization of the cell 115 can include that it is in a rural location, is on-road, and has a climate classification of “warm.” For example, the characterization of the cell 116 can include that it is in a rural location, is off-road, and has a climate classification of “warm.” For example, the characterization of the cell 117 can include that it is in a rural location, is on-road, and has a climate classification of “warm.” For example, the characterization of the cell 118 can include that it is in an urban location, is on-road, and has a climate classification of “hot.” For example, the characterization of the cell 119 can include that it is in an urban location, is on-road, and has a climate classification of “hot.” For example, the characterization of the cell 120 can include that it is in an urban location, is on-road, has a climate classification of “hot,” and is near to the body of water 104. For example, the characterization of the cell 121 can include that it is in an urban location, is on-road, has a climate classification of “hot,” and is near to the body of water 104.

Alternatively or additionally, for example, the grid 105 can include: (1) a cell 123 located at a northern area of the environment 100, (2) a cell 124 located south of the cell 123, (3) a cell 125 can be located south of the cell 124, and (4) a cell 126 located south of the cell 125. In a hierarchical arrangement, for example: (1) the cell 123 can contain the cell 106, the cell 107, the cell 108, and the cell 109, (2) the cell 124 can contain the cell 110, the cell 111, the cell 112, and the cell 113, (3) the cell 125 can contain the cell 114, the cell 115, the cell 116, and the cell 117, and (4) the cell 126 can contain the cell 118, the cell 119, the cell 120, and the cell 121. For example, each of the cell 123, the cell 124, and the cell 125 can be a square, and the cell 126 can be a rectangle.

For example, based the hierarchical arrangement, cells of the grid 105 can be members of sets of cells. For example, a first set of cells 127 can include the cell 106 and the cell 123. For example, a second set of cells 128 can include the cell 107 and the cell 123. For example, a third set of cells 129 can include the cell 108 and the cell 123. For example, a fourth set of cells 130 can include the cell 109 and the cell 123. For example, a fifth set of cells 131 can include the cell 110 and the cell 124. For example, a sixth set of cells 132 can include the cell 111 and the cell 124. For example, a seventh set of cells 133 can include the cell 112 and the cell 124. For example, an eighth set of cells 134 can include the cell 113 and the cell 124. For example, a ninth set of cells 135 can include the cell 114 and the cell 125. For example, a tenth set of cells 136 can include the cell 115 and the cell 125. For example, an eleventh set of cells 137 can include the cell 116 and the cell 125. For example, a twelfth set of cells 138 can include the cell 117 and the cell 125. For example, a thirteenth set of cells 139 can include the cell 118 and the cell 126. For example, a fourteenth set of cells 140 can include the cell 119 and the cell 126. For example, a fifteenth set of cells 141 can include the cell 120 and the cell 126. For example, a sixteenth set of cells 142 can include the cell 121 and the cell 126.

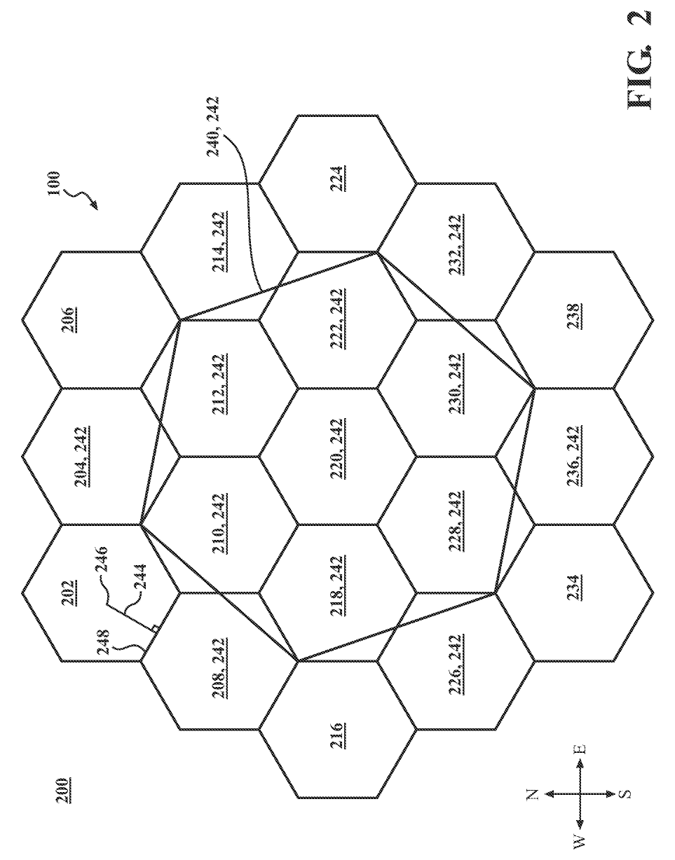

FIG. 2 includes a diagram that illustrates another example of a grid 200 for communicating a location of a vehicle, according to the disclosed technologies. The grid 200 can divide a surface of the environment 100 into contiguous cells. For example, a first row of cells at a northern area of the environment 100, from west to east, can include a cell 202, a cell 204, and a cell 206. For example, a second row of cells south of the first row of cells, from west to east, can include a cell 208, a cell 210, a cell 212, and a cell 214. For example, a third row of cells south of the second row of cells, from west to east, can include a cell 216, a cell 218, a cell 220, a cell 222, and a cell 224. For example, a fourth row of cells south of the third row of cells, from west to east, can include a cell 226, a cell 228, a cell 230, and a cell 232. For example, a fifth row of cells south of the fourth row of cells, from west to east, can include a cell 234, a cell 236, and a cell 238. Cells of the grid 200 can have a shape. For example, each of the cell 202, the cell 204, the cell 206, the cell 208, the cell 210, the cell 212, the cell 214, the cell 216, the cell 218, the cell 220, the cell 222, the cell 224, the cell 226, the cell 228, the cell 230, the cell 232, the cell 234,the cell 236, and the cell 238 can be a regular hexagon.

Alternatively or additionally, for example, the grid 200 can include a cell 240. In a hierarchical arrangement, for example, the cell 240 can contain the cell 220, a portion of the cell 204, a portion of the cell 208, a portion of the cell 210, a portion of the cell 212, a portion of the cell 214, a portion of the cell 218, a portion of the cell 222, a portion of the cell 226, a portion of the cell 228, a portion of the cell 230, a portion of the cell 232, and a portion of the cell 236. For example, the cell 240 can be a regular hexagon.

For example, based the hierarchical arrangement, cells of the grid 200 can be members of a set of cells 242. For example, the set of cells 242 can include the cell 220, the cell 204, the cell 208, the cell 210, the cell 212, the cell 214, the cell 218, the cell 222, the cell 226, the cell 228, the cell 230, the cell 232, the cell 236, and the cell 240.

For example, the grid 200 can include a preexisting grid. For example, the preexisting grid can include a grid associated with the H3 hexagonal hierarchical spatial index developed by Uber Technologies, Inc. of San Francisco, California. Based on a pattern of the grid 200, an environment of the H3 hexagonal hierarchical spatial index can include a whole surface of the Earth and can include a hierarchical arrangement of larger cells that contain at least portions of smaller cells. For example, the hierarchical arrangement can include sixteen different sizes of cells in which a size of smallest cell can be about a size of a suburban backyard and a size of a largest cell can be about a size of the continent of North America.

Returning to FIG. 1, for example, the environment 100 can include a first vehicle 143, a second vehicle 144, a third vehicle 145, a fourth vehicle 146, a fifth vehicle 147, a sixth vehicle 148, a seventh vehicle 149, an eighth vehicle 150, a ninth vehicle 151, a tenth vehicle 152, an eleventh vehicle 153, and a twelfth vehicle 154. For example, the first vehicle 143 can be located in the southbound lane 102 just north of a southern boundary of the cell 109. For example, the second vehicle 144 can be located in the southbound lane 102 just north of the first vehicle 143. For example, the third vehicle 145 can be located in the southbound lane 102 just north of the second vehicle 144. For example, the fourth vehicle 146 can be located in the national park 122. For example, the fifth vehicle 147 can be located in the southbound lane 102 in the cell 113. For example, the sixth vehicle 148 can be located in the southbound lane 102 just north of a southern boundary of the cell 117. For example, the seventh vehicle 149 can be located in the southbound lane 102 just north of the sixth vehicle 148. For example, the eighth vehicle 150 can be located in the southbound lane 102 just north of the seventh vehicle 149. For example, the ninth vehicle 151 can be located in the southbound lane 102 just north of the eighth vehicle 150. For example, the tenth vehicle 152 can be located in the northbound lane 103 just south of a northern boundary of the cell 119. For example, the eleventh vehicle 153 can be located in the northbound lane 103 just south of the tenth vehicle 152. For example, the twelfth vehicle 154 can be located in the northbound lane 103 just south of the eleventh vehicle 153.

For example, the second vehicle 144 can include a processor 155, a memory 156, a sensor 157, and a wireless communications device 158. For example, the fifth vehicle 147 can include a processor 159, a memory 160, a sensor 161, and a wireless communications device 162. For example, the seventh vehicle 149 can include a processor 163, a memory 164, a sensor 165, and a wireless communications device 166. For example, the eleventh vehicle 153 can include a processor 167, a memory 168, a sensor 169, and a wireless communications device 170.

For example, the environment 100 can include a first cloud computing platform 171, a second cloud computing platform 172, and a third cloud computing platform 173.

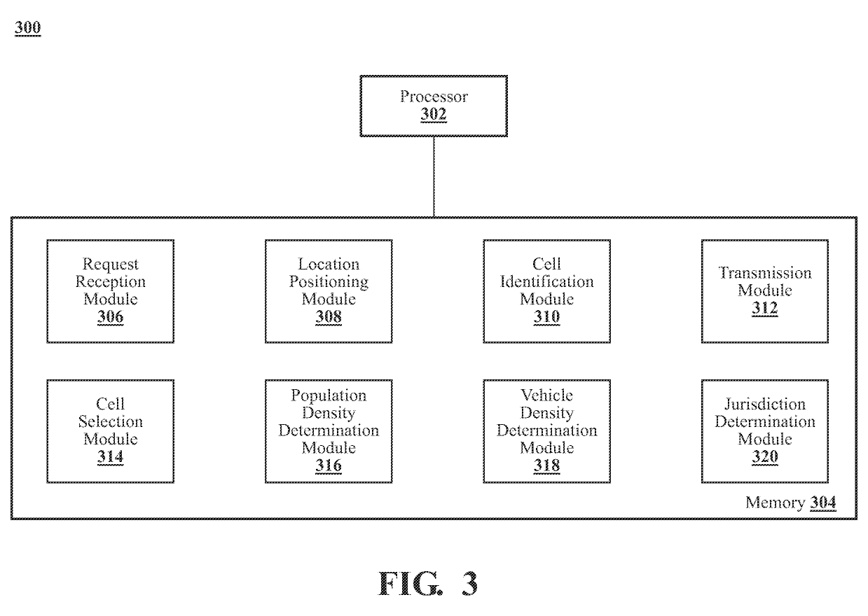

FIG. 3 includes a block diagram that illustrates an example of a system 300 for communicating a location of a vehicle, according to the disclosed technologies. The system 300 can include, for example, a processor 302 and a memory 304. The memory 304 can be communicably coupled to the processor 302. For example, the memory 304 can store a request reception module 306, a location positioning module 308, a cell identification module 310, and a transmission module 312.

For example, the request reception module 306 can include instructions that function to control the processor 302 to receive a request for the location of the vehicle. With reference to FIG. 1, for example, the vehicle can be the second vehicle 144. For example, the processor 155 can receive, via the wireless communications device 158 and from the first cloud computing platform 171, the request for the location of the second vehicle 144.

Returning to FIG. 3, for example, the location positioning module 308 can include instructions that function to control the processor 302 to determine a precise location of the vehicle. For example, the instructions to determine the precise location of the vehicle can include instructions to determine, using a technique, the precise location of the vehicle. For example, the technique can include one or more of: (1) a Global Navigation Satellite System (GNSS) technique, (2) a cellular network triangulation technique, (3) a technique that determines a location of a hotspot at which Internet access is obtainable via a wireless local-area network, (4) a technique that uses one or more of a gyroscope, disposed on the vehicle, or an accelerometer disposed on the vehicle, (5) a technique that uses a radio-frequency identification tag, (6) a technique that uses radio beacons, (7) a technique that uses surveillance cameras, (8) a technique that uses automatic number-plate recognition technology, or (9) the like.

For example, the cell identification module 310 can include instructions that function to control the processor 302 to determine an identification of a cell that contains the precise location of the vehicle. With reference to FIG. 1, for example, the vehicle can be the second vehicle 144. For example, the processor 155 can determine the identification of the cell 109 that contains the precise location of the second vehicle 144.

For example, the cell can be of a grid that divides a surface of the Earth into contiguous cells. For example, the surface of the Earth can include a whole surface of the Earth. For example, the grid can include a preexisting grid. With reference to FIG. 2, for example, the preexisting grid can include a grid associated with the H3 hexagonal hierarchical spatial index developed by Uber Technologies, Inc. of San Francisco, California.

With reference to FIGS. 1 and 2, for example, cells, of the contiguous cells, can have one or more shapes. For example, the one or more shapes can include one or more of a square, a rectangle, a diamond, a triangle, a pentagon, a hexagon, or the like. For example, a specific cell, of the contiguous cells, can have a specific size. For example, the specific size can be a size deemed large enough to complicate an ability of an entity to obtain, using the identification of the cell, information capable of identifying an occupant of the vehicle. For example, the information capable of identifying the occupant of the vehicle can include one or more of a real name of the occupant, an alias name of the occupant, a postal address of the occupant, a telephone number of the occupant, an e-mail address of the occupant, a social media account identifier of the occupant, credit card information associated with the occupant, a username associated with the occupant, a driver’s license number of the occupant, a license plate number of a vehicle associated with the occupant, a vehicle identification number (VIN) of the vehicle associated with the occupant, geolocation information associated with the occupant, or the like. For example, the specific size can be defined by a shortest distance from a center of the specific cell to an edge of the specific cell. With reference to FIG. 1, for example: (1) a specific size of the cell 119 can be defined by a shortest distance 174 from a center 175 of the cell 119 to an edge 176 of the cell 119 and (2) a specific size of the cell 120 can be defined by a shortest distance 177 from a center 178 of the cell 120 to an edge 179 of the cell 120. With reference to FIG. 2, for example, a specific size of the cell 202 can be defined by a shortest distance 244 from a center 246 of the cell 202 to an edge 248 of the cell 202.

Returning to FIG. 3, for example, the transmission module 312 can include instructions that function to control the processor 302 to cause, in response to the request, a transmission of the identification of the cell, rather than the precise location of the vehicle, in order to complicate the ability of the entity to obtain the information capable of identifying the occupant of the vehicle. With reference to FIG. 1, for example, the vehicle can be the second vehicle 144. For example, the processor 155 can cause, in response to the request from the first cloud computing platform 171, the transmission of the identification of the cell 109.

Additionally, for example: (1) the cell that contains the precise location of the vehicle can include a set of cells and (2) the identification of the cell that contains the precise location of the vehicle can include a set of identifications of the set of cells. For example, each cell, of the set of cells, can have: (1) a corresponding identification of the set of identifications and (2) a corresponding size. For example, a corresponding size of a first cell, of the set of cells, can be larger than a corresponding size of a second cell of the set of cells. For example, the first cell can contain at least a portion of the second cell. For example, a shape of the first cell can be a shape of the second cell. Alternatively, for example, the shape of the first cell can be different from the shape of the second cell. With reference to FIG. 1, for example: (1) the vehicle can be the second vehicle 144, (2) the set of cells can be the fourth set of cells 130, (3) the first cell can be the cell 123, (4) the second cell can be the cell 109, and (5) the set of identifications can include the identification of the cell 123 and the identification of the cell 109.

Returning to FIG. 3, for example, the memory 304 can further store a cell selection module 314. For example, the cell selection module 314 can include instructions that function to control the processor 302 to select, from the set of cells, a specific cell that has a size deemed large enough to complicate the ability of the entity to obtain, using the identification of the specific cell, the information capable of identifying the occupant of the vehicle. For example, the instructions to cause the transmission of the identification of the cell can include instructions to cause the transmission of an identification of the specific cell.

Alternatively or additionally, for example, the specific size can be a function of a population density at the precise location of the vehicle. For example, the memory 304 can further store a population density determination module 316. For example, the population density determination module 316 can include instructions that function to control the processor 302 to obtain, based on the precise location of the vehicle, information about the population density. With reference to FIG. 1, for example, the vehicle can be the fifth vehicle 147. For example, the processor 159 can determine that the eighth set of cells 134, which includes the cell 113 and the cell 124, contains the precise location of the fifth vehicle 147. For example, the processor 159 can receive, based on the precise location of the fifth vehicle 147, via the wireless communications device 162, and from the second cloud computing platform 172, the information about the population density at the precise location of the fifth vehicle 147. For example, the second cloud computing platform 172 can be a server for government information. For example, because the precise location of the fifth vehicle 147 is a rural location (i.e., a sparse population density), the processor 159 can select, from the eighth set of cells 134, the cell 124 as the cell that has the size deemed large enough to complicate the ability of the entity to obtain, using the identification of the cell 124, the information capable of identifying the occupant of the fifth vehicle 147. For example, the processor 159 can cause, in response to the request from the first cloud computing platform 171, the transmission of the identification of the cell 124.

Returning to FIG. 3, alternatively or additionally, for example, the specific size can be a function of a vehicle density at the precise location of the vehicle. For example, the memory 304 can further store a vehicle density determination module 318. For example, the vehicle density determination module 318 can include instructions that function to control the processor 302 to obtain, based on the precise location of the vehicle, at least an estimate of a count of a number of vehicles within a specific area centered on the precise location of the vehicle. With reference to FIG. 1, for example, the vehicle can be the seventh vehicle 149. For example, the processor 163 can determine that the twelfth set of cells 138, which includes the cell 117 and the cell 125, contains the precise location of the seventh vehicle 149. For example, the sensor 165 can include one or more imaging devices or ranging devices. Imaging devices can include, for example, a camera, a color camera, a stereoscopic camera, a video camera, a digital video camera, or the like. Ranging devices can include, for example, ultrasonic imaging devices, infrared imaging devices, radar devices, lidar devices, ultrasonic ranging devices, infrared ranging devices, or the like. For example, the processor 163 can determine, based on the precise location of the seventh vehicle 149, at least the estimate of the count of the number of vehicles within the specific area centered on the precise location of the seventh vehicle 149. For example, although the precise location of the seventh vehicle 149 is a rural location (i.e., a sparse population density), because the at least the estimate of the count of the number of vehicles within the specific area centered on the precise location of the seventh vehicle 149 is large (i.e., a dense vehicle density), the processor 163 can select, from the twelfth set of cells 138, the cell 117 as the cell that has the size deemed large enough to complicate the ability of the entity to obtain, using the identification of the cell 117, the information capable of identifying the occupant of the seventh vehicle 149. For example, the processor 163 can cause, in response to the request from the first cloud computing platform 171, the transmission of the identification of the cell 117.

Returning to FIG. 3, alternatively or additionally, for example, a requirement of the specific size can be defined by one or more of a law, a statute, a regulation, a rule, or the like. For example, if the precise location of the vehicle is in the European Union, then the specific size can be defined by the General Data Protection Regulation. For example, if the precise location of the vehicle is in California, then the specific size can be defined by the California Consumer Privacy Act as 1,850 feet. For example, the memory 304 can further store a jurisdiction determination module 320. For example, the jurisdiction determination module 320 can include instructions that function to control the processor 302 to obtain, based on the precise location of the vehicle, information about at least one of the one or more of the law, the statute, the regulation, the rule, or the like that includes the requirement of the specific size. With reference to FIG. 1, for example, the vehicle can be the eleventh vehicle 153. For example, the processor 167 can determine, based on the precise location of the eleventh vehicle 153, that the eleventh vehicle 153 is in California. For example, the processor 167 can determine that the fourteenth set of cells 140, which includes the cell 119 and the cell 126, contains the precise location of the eleventh vehicle 153. For example, the processor 167 can receive, based on the precise location of the eleventh vehicle 153, via the wireless communications device 162, and from the second cloud computing platform 172, information about at least one of the one or more of the law, the statute, the regulation, or the rule that includes the requirement of the specific size. For example, the second cloud computing platform 172 can be a server for government information. For example, although the precise location of the eleventh vehicle 153 is an urban location (i.e., a dense population density and a dense vehicle density), because: (1) the precise location of the eleventh vehicle 153 is in California, (2) the specific size of the cell 119, defined by the shortest distance 174, is 1,000 feet, (3) the specific size of the cell 120, defined by the shortest distance 177, is 900 feet, and (4) the requirement of the specific size, defined by the California Consumer Privacy Act, is 1,850 feet, the processor 167 can select, from the fourteenth set of cells 140, the cell 126 as the cell that has the size deemed large enough to complicate the ability of the entity to obtain, using the identification of the cell 126, the information capable of identifying the occupant of the eleventh vehicle 153. For example, the processor 167 can cause, in response to the request from the first cloud computing platform 171, the transmission of the identification of the cell 126.

Additionally, for example, the identification of the cell can include a spatial index of a spatial database. For example, the spatial database can include supplemental information associated with a location of the cell. For example, the supplemental information can include a characterization of the location of the cell with respect to one or more of: (1) being urban or rural, (2) being on-road or off-road, (3) a climate classification, (4) including or being near to a body of water, (5) one or more identifications of one or more attractions, or (6) the like. For example, the third cloud computing platform 173 can include the spatial database. For example, after a receipt of the identification of the cell 109 as a response to the request for the location of the second vehicle 144, the first cloud computing platform 171 can: (1) transmit, to the third cloud computing platform 173, a request for supplemental information associated with the location of the cell 109 and (2) receive, from the third cloud computing platform 173, information that characterizes the cell 109 as being in an urban location, being on-road, and having a climate classification of “cold.” For example, after a receipt of the identification of the cell 124 as a response to the request for the location of the fifth vehicle 147, the first cloud computing platform 171 can: (1) transmit, to the third cloud computing platform 173, a request for supplemental information associated with the location of the cell 124 and (2) receive, from the third cloud computing platform 173, information that characterizes the cell 124 as being in a rural location, being both on-road and off-road, having a climate classification of “cool,” and includes the national park 122. For example, after a receipt of the identification of the cell 117 as a response to the request for the location of the seventh vehicle 149, the first cloud computing platform 171 can: (1) transmit, to the third cloud computing platform 173, a request for supplemental information associated with the location of the cell 117 and (2) receive, from the third cloud computing platform 173, information that characterizes the cell 117 as being in a rural location, being on-road, and having a climate classification of “warm.” For example, after a receipt of the identification of the cell 126 as a response to the request for the location of the eleventh vehicle 153, the first cloud computing platform 171 can: (1) transmit, to the third cloud computing platform 173, a request for supplemental information associated with the location of the cell 126 and (2) receive, from the third cloud computing platform 173, information that characterizes the cell 126 as being in an urban location, being on-road, and having a climate classification of “hot,” and being near to the body of water 104.

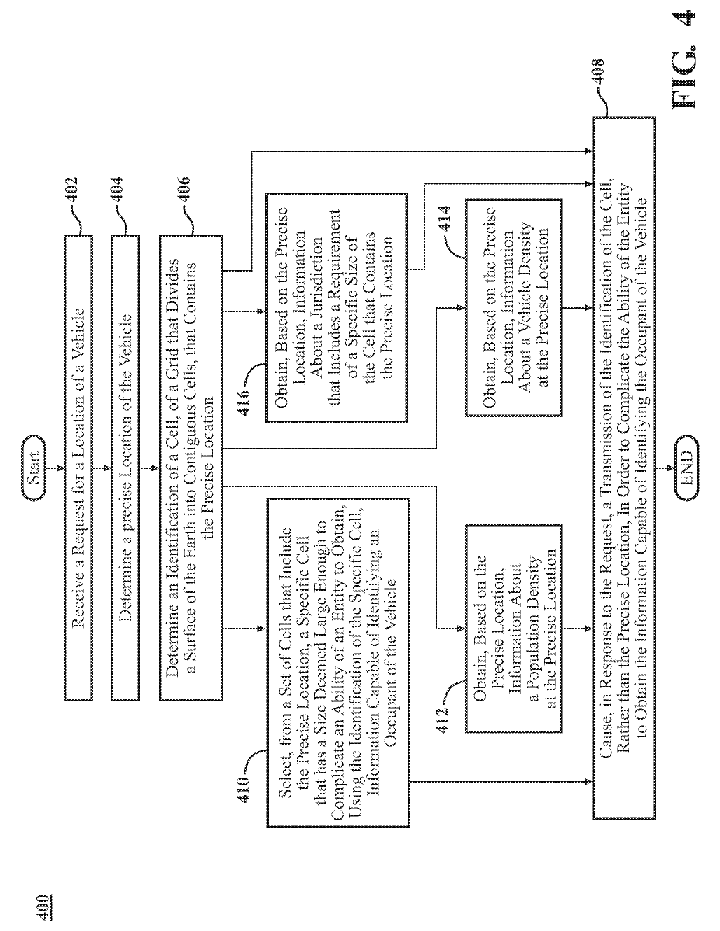

FIG. 4 includes a flow diagram that illustrates an example of a method 400 that is associated with communicating a location of a vehicle, according to the disclosed technologies. Although the method 400 is described in combination with the system 300 illustrated in FIG. 3, one of skill in the art understands, in light of the description herein, that the method 400 is not limited to being implemented by the system 300 illustrated in FIG. 3. Rather, the system 300 illustrated in FIG. 3 is an example of a system that may be used to implement the method 400. Additionally, although the method 400 is illustrated as a generally serial process, various aspects of the method 400 may be able to be executed in parallel.

In the method 400, at an operation 402, for example, the request reception module 306 can receive a request for the location of the vehicle.

At an operation 404, for example, the location positioning module 308 can determine a precise location of the vehicle. For example, the operation 404 can determine, using a technique, the precise location of the vehicle. For example, the technique can include one or more of: (1) a Global Navigation Satellite System (GNSS) technique, (2) a cellular network triangulation technique, (3) a technique that determines a location of a hotspot at which Internet access is obtainable via a wireless local-area network, (4) a technique that uses one or more of a gyroscope, disposed on the vehicle, or an accelerometer disposed on the vehicle, (5) a technique that uses a radio-frequency identification tag, (6) a technique that uses radio beacons, (7) a technique that uses surveillance cameras, (8) a technique that uses automatic number-plate recognition technology, or (9) the like.

At an operation 406, for example, the cell identification module 310 can determine an identification of a cell that contains the precise location of the vehicle.

For example, the cell can be of a grid that divides a surface of the Earth into contiguous cells. For example, the surface of the Earth can include a whole surface of the Earth. For example, the grid can include a preexisting grid. For example, the preexisting grid can include a grid associated with the H3 hexagonal hierarchical spatial index developed by Uber Technologies, Inc. of San Francisco, California.

For example, cells, of the contiguous cells, can have one or more shapes. For example, the one or more shapes can include one or more of a square, a rectangle, a diamond, a triangle, a pentagon, a hexagon, or the like. For example, a specific cell, of the contiguous cells, can have a specific size. For example, the specific size can be a size deemed large enough to complicate an ability of an entity to obtain, using the identification of the cell, information capable of identifying an occupant of the vehicle. For example, the information capable of identifying the occupant of the vehicle can include one or more of a real name of the occupant, an alias name of the occupant, a postal address of the occupant, a telephone number of the occupant, an e-mail address of the occupant, a social media account identifier of the occupant, credit card information associated with the occupant, a username associated with the occupant, a driver’s license number of the occupant, a license plate number of a vehicle associated with the occupant, a vehicle identification number (VIN) of the vehicle associated with the occupant, geolocation information associated with the occupant, or the like. For example, the specific size can be defined by a shortest distance from a center of the specific cell to an edge of the specific cell.

At an operation 408, for example, the transmission module 312 can cause, in response to the request, a transmission of the identification of the cell, rather than the precise location of the vehicle, in order to complicate the ability of the entity to obtain the information capable of identifying the occupant of the vehicle.

Additionally, for example: (1) the cell that contains the precise location of the vehicle can include a set of cells and (2) the identification of the cell that contains the precise location of the vehicle can include a set of identifications of the set of cells. For example, each cell, of the set of cells, can have: (1) a corresponding identification of the set of identifications and (2) a corresponding size. For example, a corresponding size of a first cell, of the set of cells, can be larger than a corresponding size of a second cell of the set of cells. For example, the first cell can contain at least a portion of the second cell. For example, a shape of the first cell can be a shape of the second cell. Alternatively, for example, the shape of the first cell can be different from the shape of the second cell. Additionally, at an operation 410, for example, the cell selection module 314 can select, from the set of cells, a specific cell that has a size deemed large enough to complicate the ability of the entity to obtain, using the identification of the specific cell, the information capable of identifying the occupant of the vehicle. For example, the operation 408 can cause the transmission of an identification of the specific cell.

Alternatively or additionally, for example, the specific size can be a function of a population density at the precise location of the vehicle. Additionally, at an operation 412, for example, the population density determination module 316 can obtain, based on the precise location of the vehicle, information about the population density.

Alternatively or additionally, for example, the specific size can be a function of a vehicle density at the precise location of the vehicle. Additionally, at an operation 414, for example, the vehicle density determination module 318 can obtain, based on the precise location of the vehicle, at least an estimate of a count of a number of vehicles within a specific area centered on the precise location of the vehicle.

Alternatively or additionally, for example, a requirement of the specific size can be defined by one or more of a law, a statute, a regulation, a rule, or the like. For example, if the precise location of the vehicle is in the European Union, then the specific size can be defined by the General Data Protection Regulation. For example, if the precise location of the vehicle is in California, then the specific size can be defined by the California Consumer Privacy Act as 1,850 feet. Additionally, at an operation 416, for example, the jurisdiction determination module 320 can obtain, based on the precise location of the vehicle, information about at least one of the one or more of the law, the statute, the regulation, the rule, or the like that includes the requirement of the specific size.

Additionally, for example, the identification of the cell can include a spatial index of a spatial database. For example, the spatial database can include supplemental information associated with a location of the cell. For example, the supplemental information can include a characterization of the location of the cell with respect to one or more of: (1) being urban or rural, (2) being on-road or off-road, (3) a climate classification, (4) including or being near to a body of water, (5) one or more identifications of one or more attractions, or (6) the like.

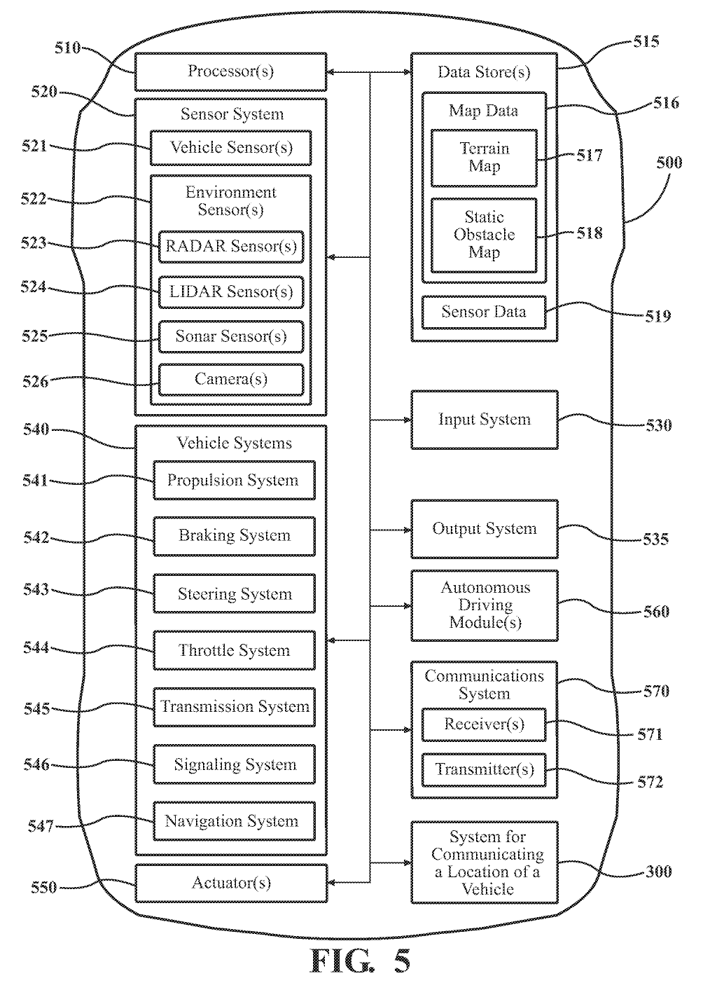

FIG. 5 includes a block diagram that illustrates an example of elements disposed on a vehicle 500, according to the disclosed technologies. As used herein, a “vehicle” can be any form of powered transport. In one or more implementations, the vehicle 500 can be an automobile. While arrangements described herein are with respect to automobiles, one of skill in the art understands, in light of the description herein, that embodiments are not limited to automobiles. For example, functions and/or operations of one or more of the second vehicle 144, the fifth vehicle 147, the seventh vehicle 149, and the eleventh vehicle 153 (illustrated in FIG. 1) can be realized by the vehicle 500.

In some embodiments, the vehicle 500 can be configured to switch selectively between an automated mode, one or more semi-automated operational modes, and/or a manual mode. Such switching can be implemented in a suitable manner, now known or later developed. As used herein, “manual mode” can refer that all of or a majority of the navigation and/or maneuvering of the vehicle 500 is performed according to inputs received from a user (e.g., human driver). In one or more arrangements, the vehicle 500 can be a conventional vehicle that is configured to operate in only a manual mode.

In one or more embodiments, the vehicle 500 can be an automated vehicle. As used herein, “automated vehicle” can refer to a vehicle that operates in an automated mode. As used herein, “automated mode” can refer to navigating and/or maneuvering the vehicle 500 along a travel route using one or more computing systems to control the vehicle 500 with minimal or no input from a human driver. In one or more embodiments, the vehicle 500 can be highly automated or completely automated. In one embodiment, the vehicle 500 can be configured with one or more semi-automated operational modes in which one or more computing systems perform a portion of the navigation and/or maneuvering of the vehicle along a travel route, and a vehicle operator (i.e., driver) provides inputs to the vehicle 500 to perform a portion of the navigation and/or maneuvering of the vehicle 500 along a travel route.

For example, Standard J3016 202104, Taxonomy and Definitions for Terms Related to Driving Automation Systems for On-Road Motor Vehicles, issued by the Society of Automotive Engineers (SAE) International on January 16, 2014, and most recently revised on April 30, 2021, defines six levels of driving automation. These six levels include: (1) level 0, no automation, in which all aspects of dynamic driving tasks are performed by a human driver; (2) level 1, driver assistance, in which a driver assistance system, if selected, can execute, using information about the driving environment, either steering or acceleration/deceleration tasks, but all remaining driving dynamic tasks are performed by a human driver; (3) level 2, partial automation, in which one or more driver assistance systems, if selected, can execute, using information about the driving environment, both steering and acceleration/deceleration tasks, but all remaining driving dynamic tasks are performed by a human driver; (4) level 3, conditional automation, in which an automated driving system, if selected, can execute all aspects of dynamic driving tasks with an expectation that a human driver will respond appropriately to a request to intervene; (5) level 4, high automation, in which an automated driving system, if selected, can execute all aspects of dynamic driving tasks even if a human driver does not respond appropriately to a request to intervene; and (6) level 5, full automation, in which an automated driving system can execute all aspects of dynamic driving tasks under all roadway and environmental conditions that can be managed by a human driver.

The vehicle 500 can include various elements. The vehicle 500 can have any combination of the various elements illustrated in FIG. 5. In various embodiments, it may not be necessary for the vehicle 500 to include all of the elements illustrated in FIG. 5. Furthermore, the vehicle 500 can have elements in addition to those illustrated in FIG. 5. While the various elements are illustrated in FIG. 5 as being located within the vehicle 500, one or more of these elements can be located external to the vehicle 500. Furthermore, the elements illustrated may be physically separated by large distances. For example, as described, one or more components of the disclosed system can be implemented within the vehicle 500 while other components of the system can be implemented within a cloud-computing environment, as described below. For example, the elements can include one or more processors 510, one or more data stores 515, a sensor system 520, an input system 530, an output system 535, vehicle systems 540, one or more actuators 550, one or more automated driving modules 560, a communications system 570, and the system 300 for communicating a location of a vehicle.

In one or more arrangements, the one or more processors 510 can be a main processor of the vehicle 500. For example, the one or more processors 510 can be an electronic control unit (ECU). For example, functions and/or operations of one or more of the processor 155, the processor 159, the processor 163, the processor 167 (illustrated in FIG. 1), or the processor 302 (illustrated in FIG. 3) can be realized by the one or more processors 510.

The one or more data stores 515 can store, for example, one or more types of data. The one or more data stores 515 can include volatile memory and/or non-volatile memory. Examples of suitable memory for the one or more data stores 515 can include Random-Access Memory (RAM), flash memory, Read-Only Memory (ROM), Programmable Read-Only Memory (PROM), Erasable Programmable Read-Only Memory (EPROM), Electrically Erasable Programmable Read-Only Memory (EEPROM), registers, magnetic disks, optical disks, hard drives, any other suitable storage medium, or any combination thereof. The one or more data stores 515 can be a component of the one or more processors 510. Additionally or alternatively, the one or more data stores 515 can be operatively connected to the one or more processors 510 for use thereby. As used herein, “operatively connected” can include direct or indirect connections, including connections without direct physical contact. As used herein, a statement that a component can be “configured to” perform an operation can be understood to mean that the component requires no structural alterations, but merely needs to be placed into an operational state (e.g., be provided with electrical power, have an underlying operating system running, etc.) in order to perform the operation. For example, functions and/or operations of one or more of the memory 156, the memory 160, the memory 164, the memory 168 (illustrated in FIG. 1), or the memory 304 (illustrated in FIG. 3) can be realized by the one or more data stores 515.

In one or more arrangements, the one or more data stores 515 can store map data 516. The map data 516 can include maps of one or more geographic areas. In some instances, the map data 516 can include information or data on roads, traffic control devices, road markings, structures, features, and/or landmarks in the one or more geographic areas. The map data 516 can be in any suitable form. In some instances, the map data 516 can include aerial views of an area. In some instances, the map data 516 can include ground views of an area, including 360-degree ground views. The map data 516 can include measurements, dimensions, distances, and/or information for one or more items included in the map data 516 and/or relative to other items included in the map data 516. The map data 516 can include a digital map with information about road geometry. The map data 516 can be high quality and/or highly detailed.

In one or more arrangements, the map data 516 can include one or more terrain maps 517. The one or more terrain maps 517 can include information about the ground, terrain, roads, surfaces, and/or other features of one or more geographic areas. The one or more terrain maps 517 can include elevation data of the one or more geographic areas. The map data 516 can be high quality and/or highly detailed. The one or more terrain maps 517 can define one or more ground surfaces, which can include paved roads, unpaved roads, land, and other things that define a ground surface.

In one or more arrangements, the map data 516 can include one or more static obstacle maps 518. The one or more static obstacle maps 518 can include information about one or more static obstacles located within one or more geographic areas. A “static obstacle” can be a physical object whose position does not change (or does not substantially change) over a period of time and/or whose size does not change (or does not substantially change) over a period of time. Examples of static obstacles can include trees, buildings, curbs, fences, railings, medians, utility poles, statues, monuments, signs, benches, furniture, mailboxes, large rocks, and hills. The static obstacles can be objects that extend above ground level. The one or more static obstacles included in the one or more static obstacle maps 518 can have location data, size data, dimension data, material data, and/or other data associated with them. The one or more static obstacle maps 518 can include measurements, dimensions, distances, and/or information for one or more static obstacles. The one or more static obstacle maps 518 can be high quality and/or highly detailed. The one or more static obstacle maps 518 can be updated to reflect changes within a mapped area.

In one or more arrangements, the one or more data stores 515 can store sensor data 519. As used herein, “sensor data” can refer to any information about the sensors with which the vehicle 500 can be equipped including the capabilities of and other information about such sensors. The sensor data 519 can relate to one or more sensors of the sensor system 520. For example, in one or more arrangements, the sensor data 519 can include information about one or more lidar sensors 524 of the sensor system 520.

In some arrangements, at least a portion of the map data 516 and/or the sensor data 519 can be located in one or more data stores 515 that are located onboard the vehicle 500. Additionally or alternatively, at least a portion of the map data 516 and/or the sensor data 519 can be located in one or more data stores 515 that are located remotely from the vehicle 500.

The sensor system 520 can include one or more sensors. As used herein, a “sensor” can refer to any device, component, and/or system that can detect and/or sense something. The one or more sensors can be configured to detect and/or sense in real-time. As used herein, the term “real-time” can refer to a level of processing responsiveness that is perceived by a user or system to be sufficiently immediate for a particular process or determination to be made, or that enables the processor to keep pace with some external process.

In arrangements in which the sensor system 520 includes a plurality of sensors, the sensors can work independently from each other. Alternatively, two or more of the sensors can work in combination with each other. In such a case, the two or more sensors can form a sensor network. The sensor system 520 and/or the one or more sensors can be operatively connected to the one or more processors 510, the one or more data stores 515, and/or another element of the vehicle 500 (including any of the elements illustrated in FIG. 5). The sensor system 520 can acquire data of at least a portion of the external environment of the vehicle 500 (e.g., nearby vehicles). The sensor system 520 can include any suitable type of sensor. Various examples of different types of sensors are described herein. However, one of skill in the art understands that the embodiments are not limited to the particular sensors described herein.

The sensor system 520 can include one or more vehicle sensors 521. The one or more vehicle sensors 521 can detect, determine, and/or sense information about the vehicle 500 itself. In one or more arrangements, the one or more vehicle sensors 521 can be configured to detect and/or sense position and orientation changes of the vehicle 500 such as, for example, based on inertial acceleration. In one or more arrangements, the one or more vehicle sensors 521 can include one or more accelerometers, one or more gyroscopes, an inertial measurement unit (IMU), a dead-reckoning system, a global navigation satellite system (GNSS), a global positioning system (GPS), a navigation system 547, and /or other suitable sensors. The one or more vehicle sensors 521 can be configured to detect and/or sense one or more characteristics of the vehicle 500. In one or more arrangements, the one or more vehicle sensors 521 can include a speedometer to determine a current speed of the vehicle 500.

Additionally or alternatively, the sensor system 520 can include one or more environment sensors 522 configured to acquire and/or sense driving environment data. As used herein, “driving environment data” can include data or information about the external environment in which a vehicle is located or one or more portions thereof. For example, the one or more environment sensors 522 can be configured to detect, quantify, and/or sense obstacles in at least a portion of the external environment of the vehicle 500 and/or information/data about such obstacles. Such obstacles may be stationary objects and/or dynamic objects. The one or more environment sensors 522 can be configured to detect, measure, quantify, and/or sense other things in the external environment of the vehicle 500 such as, for example, lane markers, signs, traffic lights, traffic signs, lane lines, crosswalks, curbs proximate the vehicle 500, off-road objects, etc. For example, functions and/or operations of one or more of the sensor 157, the sensor 161, the sensor 165, or the sensor 169 (illustrated in FIG. 1) can be realized by the one or more environment sensors 522.

Various examples of sensors of the sensor system 520 are described herein. The example sensors may be part of the one or more vehicle sensors 521 and/or the one or more environment sensors 522. However, one of skill in the art understands that the embodiments are not limited to the particular sensors described.

In one or more arrangements, the one or more environment sensors 522 can include one or more radar sensors 523, one or more lidar sensors 524, one or more sonar sensors 525, and/or one more cameras 526. In one or more arrangements, the one or more cameras 526 can be one or more high dynamic range (HDR) cameras or one or more infrared (IR) cameras. For example, the one or more cameras 526 can be used to record a reality of a state of an item of information that can appear in the digital map.

The input system 530 can include any device, component, system, element, arrangement, or groups thereof that enable information/data to be entered into a machine. The input system 530 can receive an input from a vehicle passenger (e.g., a driver or a passenger). The output system 535 can include any device, component, system, element, arrangement, or groups thereof that enable information/data to be presented to a vehicle passenger (e.g., a driver or a passenger).

Various examples of the one or more vehicle systems 540 are illustrated in FIG. 5. However, one of skill in the art understands that the vehicle 500 can include more, fewer, or different vehicle systems. Although particular vehicle systems can be separately defined, each or any of the systems or portions thereof may be otherwise combined or segregated via hardware and/or software within the vehicle 500. For example, the one or more vehicle systems 540 can include a propulsion system 541, a braking system 542, a steering system 543, a throttle system 544, a transmission system 545, a signaling system 546, and/or the navigation system 547. Each of these systems can include one or more devices, components, and/or a combination thereof, now known or later developed.

The navigation system 547 can include one or more devices, applications, and/or combinations thereof, now known or later developed, configured to determine the geographic location of the vehicle 500 and/or to determine a travel route for the vehicle 500. The navigation system 547 can include one or more mapping applications to determine a travel route for the vehicle 500. The navigation system 547 can include a global positioning system, a local positioning system, a geolocation system, and/or a combination thereof.

The one or more actuators 550 can be any element or combination of elements operable to modify, adjust, and/or alter one or more of the vehicle systems 540 or components thereof responsive to receiving signals or other inputs from the one or more processors 510 and/or the one or more automated driving modules 560. Any suitable actuator can be used. For example, the one or more actuators 550 can include motors, pneumatic actuators, hydraulic pistons, relays, solenoids, and/or piezoelectric actuators.

The one or more processors 510 and/or the one or more automated driving modules 560 can be operatively connected to communicate with the various vehicle systems 540 and/or individual components thereof. For example, the one or more processors 510 and/or the one or more automated driving modules 560 can be in communication to send and/or receive information from the various vehicle systems 540 to control the movement, speed, maneuvering, heading, direction, etc. of the vehicle 500. The one or more processors 510 and/or the one or more automated driving modules 560 may control some or all of these vehicle systems 540 and, thus, may be partially or fully automated.

The one or more processors 510 and/or the one or more automated driving modules 560 may be operable to control the navigation and/or maneuvering of the vehicle 500 by controlling one or more of the vehicle systems 540 and/or components thereof. For example, when operating in an automated mode, the one or more processors 510 and/or the one or more automated driving modules 560 can control the direction and/or speed of the vehicle 500. The one or more processors 510 and/or the one or more automated driving modules 560 can cause the vehicle 500 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” can mean to make, force, compel, direct, command, instruct, and/or enable an event or action to occur or at least be in a state where such event or action may occur, either in a direct or indirect manner.

The communications system 570 can include one or more receivers 571 and/or one or more transmitters 572. The communications system 570 can receive and transmit one or more messages through one or more wireless communications channels. For example, the one or more wireless communications channels can be in accordance with the Institute of Electrical and Electronics Engineers (IEEE) 802.11p standard to add wireless access in vehicular environments (WAVE) (the basis for Dedicated Short-Range Communications (DSRC)), the 3rd Generation Partnership Project (3GPP) Long-Term Evolution (LTE) Vehicle-to-Everything (V2X) (LTE-V2X) standard (including the LTE Uu interface between a mobile communication device and an Evolved Node B of the Universal Mobile Telecommunications System), the 3GPP fifth generation (5G) New Radio (NR) Vehicle-to-Everything (V2X) standard (including the 5G NR Uu interface), or the like. For example, the communications system 570 can include “connected vehicle” technology. “Connected vehicle” technology can include, for example, devices to exchange communications between a vehicle and other devices in a packet-switched network. Such other devices can include, for example, another vehicle (e.g., “Vehicle to Vehicle” (V2V) technology), roadside infrastructure (e.g., “Vehicle to Infrastructure” (V2I) technology), a cloud platform (e.g., “Vehicle to Cloud” (V2C) technology), a pedestrian (e.g., “Vehicle to Pedestrian” (V2P) technology), or a network (e.g., “Vehicle to Network” (V2N) technology. “Vehicle to Everything” (V2X) technology can integrate aspects of these individual communications technologies. For example, functions and/or operations of one or more of the wireless communications device 158, the wireless communications device 162, the wireless communications device 166, or the wireless communications device 170 (illustrated in FIG. 1) can be realized by the communications system 570.

Moreover, the one or more processors 510, the one or more data stores 515, and the communications system 570 can be configured to one or more of form a micro cloud, participate as a member of a micro cloud, or perform a function of a leader of a micro cloud. A micro cloud can be characterized by a distribution, among members of the micro cloud, of one or more of one or more computing resources or one or more data storage resources in order to collaborate on executing operations. The members can include at least connected vehicles.

The vehicle 500 can include one or more modules, at least some of which are described herein. The modules can be implemented as computer-readable program code that, when executed by the one or more processors 510, implement one or more of the various processes described herein. One or more of the modules can be a component of the one or more processors 510. Additionally or alternatively, one or more of the modules can be executed on and/or distributed among other processing systems to which the one or more processors 510 can be operatively connected. The modules can include instructions (e.g., program logic) executable by the one or more processors 510. Additionally or alternatively, the one or more data store 515 may contain such instructions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 500 can include one or more automated driving modules 560. The one or more automated driving modules 560 can be configured to receive data from the sensor system 520 and/or any other type of system capable of capturing information relating to the vehicle 500 and/or the external environment of the vehicle 500. In one or more arrangements, the one or more automated driving modules 560 can use such data to generate one or more driving scene models. The one or more automated driving modules 560 can determine position and velocity of the vehicle 500. The one or more automated driving modules 560 can determine the location of obstacles, obstacles, or other environmental features including traffic signs, trees, shrubs, neighboring vehicles, pedestrians, etc.

The one or more automated driving modules 560 can be configured to receive and/or determine location information for obstacles within the external environment of the vehicle 500 for use by the one or more processors 510 and/or one or more of the modules described herein to estimate position and orientation of the vehicle 500, vehicle position in global coordinates based on signals from a plurality of satellites, or any other data and/or signals that could be used to determine the current state of the vehicle 500 or determine the position of the vehicle 500 with respect to its environment for use in either creating a map or determining the position of the vehicle 500 in respect to map data.

The one or more automated driving modules 560 can be configured to determine one or more travel paths, current automated driving maneuvers for the vehicle 500, future automated driving maneuvers and/or modifications to current automated driving maneuvers based on data acquired by the sensor system 520, driving scene models, and/or data from any other suitable source such as determinations from the sensor data 519. As used herein, “driving maneuver” can refer to one or more actions that affect the movement of a vehicle. Examples of driving maneuvers include: accelerating, decelerating, braking, turning, moving in a lateral direction of the vehicle 500, changing travel lanes, merging into a travel lane, and/or reversing, just to name a few possibilities. The one or more automated driving modules 560 can be configured to implement determined driving maneuvers. The one or more automated driving modules 560 can cause, directly or indirectly, such automated driving maneuvers to be implemented. As used herein, “cause” or “causing” means to make, command, instruct, and/or enable an event or action to occur or at least be in a state where such event or action may occur, either in a direct or indirect manner. The one or more automated driving modules 560 can be configured to execute various vehicle functions and/or to transmit data to, receive data from, interact with, and/or control the vehicle 500 or one or more systems thereof (e.g., one or more of vehicle systems 540). For example, functions and/or operations of an automotive navigation system can be realized by the one or more automated driving modules 560.

Detailed embodiments are disclosed herein. However, one of skill in the art understands, in light of the description herein, that the disclosed embodiments are intended only as examples. Therefore, specific structural and functional details disclosed herein are not to be interpreted as limiting, but merely as a basis for the claims and as a representative basis for teaching one of skill in the art to variously employ the aspects herein in virtually any appropriately detailed structure. Furthermore, the terms and phrases used herein are not intended to be limiting but rather to provide an understandable description of possible implementations. Various embodiments are illustrated in FIGS. 1-5, but the embodiments are not limited to the illustrated structure or application.

The flowchart and block diagrams in the figures illustrate the architecture, functionality, and operation of possible implementations of systems, methods, and computer program products according to various embodiments. In this regard, each block in flowcharts or block diagrams may represent a module, segment, or portion of code, which comprises one or more executable instructions for implementing the specified logical function(s). One of skill in the art understands, in light of the description herein, that, in some alternative implementations, the functions described in a block may occur out of the order depicted by the figures. For example, two blocks depicted in succession may, in fact, be executed substantially concurrently, or the blocks may be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suitable. A typical combination of hardware and software can be a processing system with computer-readable program code that, when loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and that, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. As used herein, the phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples of the computer-readable storage medium would include, in a non-exhaustive list, the following: a portable computer diskette, a hard disk drive (HDD), a solid-state drive (SSD), a read-only memory (ROM), an erasable programmable read-only memory (EPROM or flash memory), a portable compact disc read-only memory (CD-ROM), a digital versatile disc (DVD), an optical storage device, a magnetic storage device, or any suitable combination of the foregoing. As used herein, a computer-readable storage medium may be any tangible medium that can contain or store a program for use by or in connection with an instruction execution system, apparatus, or device..

Generally, modules, as used herein, include routines, programs, objects, components, data structures, and so on that perform particular tasks or implement particular data types. In further aspects, a memory generally stores such modules. The memory associated with a module may be a buffer or may be cache embedded within a processor, a random-access memory (RAM), a ROM, a flash memory, or another suitable electronic storage medium. In still further aspects, a module as used herein, may be implemented as an application-specific integrated circuit (ASIC), a hardware component of a system on a chip (SoC), a programmable logic array (PLA), or another suitable hardware component (e.g., a central processing unit (CPU), a graphics processing unit (GPU), a field-programmable gate array (FPGA), or the like) that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the disclosed technologies may be written in any combination of one or more programming languages, including an object-oriented programming language such as Java™, Smalltalk, C++, or the like, and conventional procedural programming languages such as the “C” programming language or similar programming languages. The program code may execute entirely on a user’s computer, partly on a user’s computer, as a stand-alone software package, partly on a user’s computer and partly on a remote computer, or entirely on a remote computer or server. In the latter scenario, the remote computer may be connected to the user’s computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . or . . . ” as used herein refers to and encompasses any and all possible combinations of one or more of the associated listed items. For example, the phrase “at least one of A, B, or C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing:
a request reception module including instructions that, when executed by the processor, cause the processor to receive a request for a location of a vehicle;
a location positioning module including instructions that, when executed by the processor, cause the processor to determine a precise location of a vehicle;
a cell identification module including instructions that, when executed by the processor, cause the processor to determine an identification of a cell that contains the precise location, the cell being of a grid that divides a surface of the Earth into contiguous cells; and
a transmission module including instructions that, when executed by the processor, cause the processor to cause, in response to the request, a transmission of the identification of the cell, rather than the precise location, in order to complicate an ability of an entity to obtain information capable of identifying an occupant of the vehicle.

2. The system of claim 1, wherein cells, of the contiguous cells, have at least one shape.

3. The system of claim 2, wherein the at least one shape comprises at least one of a square, a rectangle, a diamond, a triangle, a pentagon, or a hexagon.

4. The system of claim 1, wherein:
a specific cell, of the contiguous cells, has a specific size, and
the specific size is a size deemed large enough to complicate the ability of the entity to obtain, using the identification of the cell, the information capable of identifying the occupant of the vehicle.

5. The system of claim 4, wherein the specific size is defined by a shortest distance from a center of the specific cell to an edge of the specific cell.

6. The system of claim 5, wherein a requirement of the specific size is defined by at least one of a law, a statute, a regulation, or a rule.

7. The system of claim 6, wherein the memory further stores a jurisdiction determination module including instructions that, when executed by the processor, cause the processor to obtain, based on the precise location of the vehicle, information about at least one of the at least one of the law, the statute, the regulation, or the rule that includes the requirement of the specific size.

8. The system of claim 4, wherein the specific size is a function of a population density at the precise location of the vehicle.

9. The system of claim 8, wherein the memory further stores a population density determination module including instructions that, when executed by the processor, cause the processor to obtain, based on the precise location of the vehicle, information about the population density.

10. The system of claim 4, wherein the specific size is a function of a vehicle density at the precise location of the vehicle.

11. The system of claim 10, wherein the memory further stores a vehicle density determination module including instructions that, when executed by the processor, cause the processor to determine, based on the precise location of the vehicle, at least an estimate of a count of a number of vehicles within a specific area centered on the precise location of the vehicle.

12. The system of claim 1, wherein:
the cell that contains the precise location comprises a set of cells,
the identification of the cell that contains the precise location comprises a set of identifications of the set of cells,
each cell, of the set of cells, has a corresponding identification of the set of identifications,
the each cell, of the set of cells, has a corresponding size, and
a corresponding size of a first cell, of the set of cells, is larger than a corresponding size of a second cell of the set of cells.

13. The system of claim 12, wherein:
the memory further stores a cell selection module including instructions that, when executed by the processor, cause the processor to select, from the set of cells, a specific cell that has a size deemed large enough to complicate the ability of the entity to obtain, using the identification of the specific cell, the information capable of identifying the occupant of the vehicle, and
wherein the instructions to cause the transmission of the identification of the cell include instructions to cause the transmission of an identification of the specific cell.

14. The system of claim 1, wherein the grid comprises a preexisting grid.

15. The system of claim 14, wherein the surface of the Earth comprises a whole surface of the Earth.

16. The system of claim 1, wherein the identification of the cell comprises a spatial index of a spatial database, the spatial database including supplemental information associated with a location of the cell.

17. The system of claim 16, wherein the supplemental information comprises a characterization of the location of the cell with respect to at least one of:
being urban or rural,
being on-road or off-road,
a climate classification,
including or being near to a body of water, or
at least one identification of at least one attraction.

18. A method, comprising:
receiving, by a processor, a request for a location of a vehicle;
determining, by the processor, a precise location of the vehicle;
determining, by the processor, an identification of a cell that contains the precise location, the cell being of a grid that divides a surface of the Earth into contiguous cells; and
causing, by the processor and in response to the request, a transmission of the identification of the cell, rather than the precise location, in order to complicate an ability of an entity to obtain information capable of identifying an occupant of the vehicle.

19. The method of claim 18, wherein:
the determining the precise location of the vehicle comprises determining, using a technique, the precise location of the vehicle, and
the technique comprises at least one of:
a Global Navigation Satellite System (GNSS) technique,
a cellular network triangulation technique,
a technique that determines a location of a hotspot at which Internet access is obtainable via a wireless local-area network,
a technique that uses at least one of a gyroscope, disposed on the vehicle, or an accelerometer disposed on the vehicle,
a technique that uses a radio-frequency identification tag,
a technique that uses radio beacons,
a technique that uses surveillance cameras, or
a technique that uses automatic number-plate recognition technology.

20. A non-transitory computer-readable medium for communicating a location of a vehicle, the non-transitory computer-readable medium including instructions that, when executed by one or more processors, cause the one or more processors to:
receive a request for the location of the vehicle;
determine a precise location of the vehicle;
determine an identification of a cell that contains the precise location, the cell being of a grid that divides a surface of the Earth into contiguous cells; and
cause, in response to the request, a transmission of the identification of the cell, rather than the precise location, in order to complicate an ability of an entity to obtain information capable of identifying an occupant of the vehicle.
